(19) United States
(12) Patent Application Publication
(10) Pub. No.: US 2020/0265252 A1
(43) Pub. Date: Aug. 20, 2020

(54) INFORMATION PROCESSING APPARATUS AND INFORMATION PROCESSING METHOD

(71) Applicant: HONDA MOTOR CO., LTD., Tokyo (JP)

(72) Inventor: Kosuke SUZUKI, WAKO-SHI (JP)

(21) Appl. No.: 16/792,398

(22) Filed: Feb. 17, 2020

(30) Foreign Application Priority Data
Feb. 18, 2019 (JP) 2019-026460

(51) Int. Cl. G06K 9/00; G06N 20/00; G06N 7/00

(52) U.S. Cl. CPC G06K 9/00845; G06N 7/005; G06N 20/00; G06K 9/00335

(57) ABSTRACT

An information processing apparatus includes an internal camera switch information acquiring section that acquires OFF information of stopping image capturing of a user of a vehicle; a user image acquiring section that acquires an image obtained by the image capturing of the user; a vehicle information acquiring section that acquires vehicle information including behavior of the vehicle; a user information acquiring section that acquires user information that is information of the user; and emotion estimating section that, when at least the OFF information is acquired, estimates an emotion of the user based on the acquired moving body information and user information.

### CROSS-REFERENCE TO RELATED APPLICATION

This application is based upon and claims the benefit of priority from Japanese Patent Application No. 2019-026460 filed on Feb. 18, 2019, the contents of which are incorporated herein by reference.

### BACKGROUND OF THE INVENTION

### Field of the Invention

The present invention relates to an information processing apparatus and an information processing method for estimating an emotion of a user of a moving body.

### Description of the Related Art

Japanese Laid-Open Patent Publication No. 2017-138762 discloses an emotion estimation apparatus that detects the behavior of a driver using an in-vehicle camera and estimates the emotion of the driver according to the detected behavior of the driver.

### SUMMARY OF THE INVENTION

However, with the technology recorded in Japanese Laid-Open Patent Publication No. 2017-138762, it is impossible to estimate the emotion of the driver in a case where image capturing of the driver (user) by the in-vehicle camera is stopped.

The present invention takes this problem into consideration, and it is an object of the present invention to provide an information processing apparatus and an information processing method capable of estimating the emotion of the user even when the image capturing of the user is stopped.

A first aspect of the present invention is an information processing apparatus comprising an OFF information acquiring section configured to acquire OFF information of stopping image capturing of a user of a moving body; an image acquiring section configured to acquire an image obtained by the image capturing of the user; a moving body information acquiring section configured to acquire moving body information including behavior of the moving body; a user information acquiring section configured to acquire user information that is information of the user; and an estimating section configured to, when at least the OFF information is acquired, estimate an emotion of the user based on the acquired moving body information and user information.

A second aspect of the present invention is an information processing method comprising an OFF information acquiring step of acquiring OFF information of stopping image capturing of a user of a moving body; an image acquiring step of acquiring an image obtained by the image capturing of the user; a moving body information acquiring step of acquiring moving body information including behavior of the moving body; a user information acquiring step of acquiring user information that is information of the user; and an estimating step of, when at least the OFF information is acquired, estimating an emotion of the user based on the acquired moving body information and user information.

With the information processing apparatus and the information processing method of the present invention, it is possible to estimate the emotion of the user even when image capturing of the user is stopped.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a block diagram showing a configuration of an information processing apparatus;

FIG. 2 is a diagram describing an outline of an emotion estimation based on learning results of a machine learning apparatus;

FIG. 3 shows an example of a proposal provided by a virtual assistant when an emotion of a user is estimated to be “sleepy”;

FIG. 4 shows an example of a proposal provided by a virtual assistant when an emotion of a user is estimated to be “irritated”;

FIG. 5 is a flow chart showing a flow of a machine learning process performed by the machine learning apparatus;

FIG. 6 is a flow chart showing a flow of a virtual assistant control process performed by the information processing apparatus; and

FIG. 7 is a block diagram showing a configuration of an information processing apparatus.

### DESCRIPTION OF THE PREFERRED EMBODIMENTS

### First Embodiment

### Configuration of the Information Processing Apparatus

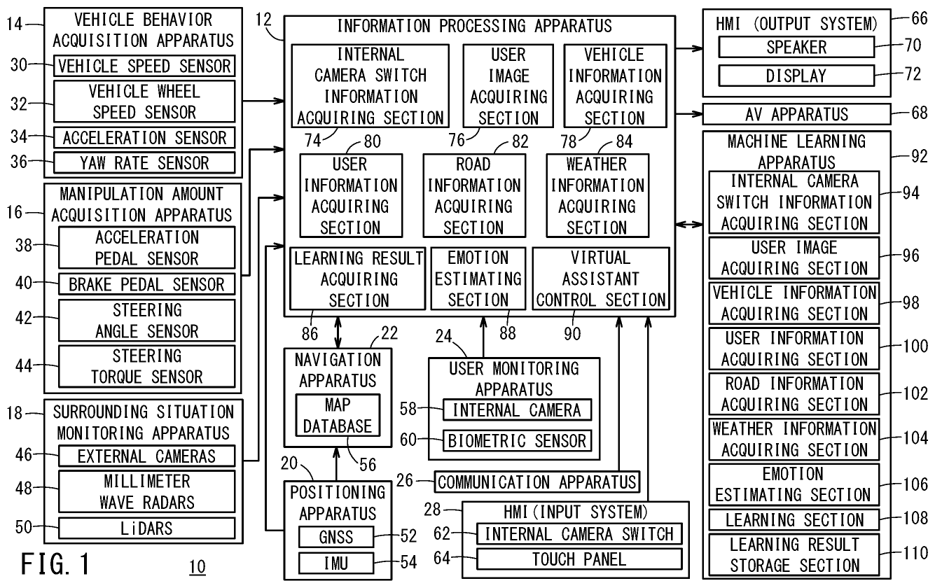

FIG. 1 is a block diagram showing the configuration of an information processing apparatus 12 loaded in a vehicle 10 according to the present embodiment. The information processing apparatus 12 of the present embodiment is loaded in the vehicle 10, but the information processing apparatus 12 may be loaded in an information processing device such as a smartphone, tablet, or personal computer that the user carries in the vehicle 10. Furthermore, the information processing apparatus 12 may be loaded in a server that is installed outside the vehicle 10 and capable of communicating with the vehicle 10. The vehicle 10 corresponds to a moving body in the present invention.

The information processing apparatus 12 estimates the emotion of the user in the vehicle 10, and provides proposals such as taking a break or playing music to the user, via a virtual assistant 112 described further below, according to the estimated emotion. Furthermore, the information processing apparatus 12 operates apparatuses inside the vehicle 10, according to the ideas proposed to the user.

The information processing apparatus 12 receives information from input apparatuses, described below, loaded in the vehicle 10. A vehicle behavior acquisition apparatus 14, a manipulation amount acquisition apparatus 16, a surrounding situation monitoring apparatus 18, a positioning apparatus 20, a navigation apparatus 22, a user monitoring apparatus 24, a communication apparatus 26, and a human-machine interface (referred to below as an HMI) 28 of an input system are loaded in the vehicle 10, as the input apparatuses.

The vehicle behavior acquisition apparatus 14 acquires vehicle behavior information of the vehicle 10. The vehicle 10 includes, as the vehicle behavior acquisition apparatus 14, a vehicle speed sensor 30 that acquires the vehicle speed, a vehicle wheel speed sensor 32 that acquires the vehicle wheel speed, an acceleration sensor 34 that acquires longitudinal acceleration, lateral acceleration, and vertical acceleration of the vehicle 10, and a yaw rate sensor 36 that acquires the yaw rate of the vehicle 10.

The manipulation amount acquisition apparatus 16 acquires manipulation amount information concerning driving manipulations performed by the user. The vehicle 10 includes, as the manipulation amount acquisition apparatus 16, an acceleration pedal sensor 38 that acquires the manipulation amount of an acceleration pedal, a brake pedal sensor 40 that acquires the manipulation amount of a brake pedal, a steering angle sensor 42 that acquires a steering angle of a steering wheel, and a steering torque sensor 44 that acquires steering torque applied to the steering wheel.

The surrounding situation monitoring apparatus 18 monitors the surrounding situation the vehicle 10. The surrounding situation indicates the situation of other vehicles, buildings, signs, and lanes around the vehicle 10. The vehicle 10 includes, as the surrounding situation monitoring apparatus 18, a plurality of external cameras 46 that capture images outside the vehicle 10, a plurality of millimeter wave radars 48 that acquire the distances between the vehicle 10 and detected objects or the like using millimeter waves, and a plurality of laser radars (LiDAR) 50 that acquire the distance between the vehicle 10 and detected objects or the like using laser light (infrared rays).

The positioning apparatus 20 acquires position information of the vehicle 10. The vehicle 10 includes, as the positioning apparatus 20, a global navigation satellite system (GLASS) 52 that measures the position of the vehicle 10 using signals emitted from an artificial satellite and an inertial measurement unit (IMU) 54 that acquires the three-dimensional behavior of the vehicle 10 using a three-axis gyro and a three-direction acceleration sensor.

The navigation apparatus 22 displays a map created based on a map database 56 in a display 72, described further below, and displays position information of the vehicle 10 acquired by the positioning apparatus 20 on this map. Furthermore, the navigation apparatus 22 sets a destination of the vehicle 10 based on a manipulation of a touch panel 64, described further below, by the user, and sets a target route to the destination from the current position of the vehicle 10. The navigation apparatus 22 controls the display 72 to display route guidance based on the set target route. The navigation apparatus 22 controls a speaker 70, described further below, to vocally announce the route guidance based on the set target route. The information in the map database 56 and information concerning target values and the target route set by the navigation apparatus 22 are input to the information processing apparatus 12. The map database 56 need not necessarily be loaded in the vehicle 10, or may acquire the map information from a server installed outside the vehicle 10, via the communication apparatus 26 described further below. Furthermore, the navigation apparatus 22 may acquire road information such as traffic information and construction information from an intelligent transport system (ITS) or the like, via the communication apparatus 26, and control the display 72 to display this road information on the map.

The user monitoring apparatus 24 monitors the state of the user. The vehicle 10 includes, as the user monitoring apparatus 24, an internal camera 58 that captures an image of the user in the vehicle 10 and a biometric sensor 60 that measures biometric information such as the heart rate, pulse, brainwaves, or respiratory rate of the user in the vehicle 10. The biometric sensor 60 may be loaded at a location touched by the hand of the user, such as the steering wheel, loaded at a location touched by the body of the user, such as a seat of the vehicle 10, or loaded on a wearable terminal worn on the body of the user. Furthermore, the biometric sensor 60 may be a non-contact type that irradiates the user with radio waves and measures the biometric information of the user from the reflected radio waves.

The communication apparatus 26 performs wireless communication with external devices (not shown in the drawings). The external devices are a road information distribution server that distributes road information such as traffic information or construction information, a weather information distribution server that distributes weather information, and the like, for example. The communication apparatus 26 may be provided in a specialized manner to the vehicle 10, such as in the case of a telematics control unit (TCU), or a mobile telephone, smartphone, or the like may be used as the communication apparatus 26.

The HMI 28 of the input system is manipulated by the user to transmit prescribed signals to the information processing apparatus 12. The vehicle 10 of the present embodiment uses an internal camera switch 62 and the touch panel 64 as the HMI 28 of the input system.

The internal camera switch 62 is a switch for switching between an ON state in which an image of the user is captured by the internal camera 58, described further below, and an OFF state in which image capturing of the user by the internal camera 58 is stopped.

The touch panel 64 is a transparent film-shaped member adhered to the screen of the display 72, described further below, and acquires manipulation position information concerning a position touched by the finger, stylus, or the like of the user. The information processing apparatus 12 receives instructions from the user, based on the relationship between the manipulation position information acquired by the touch panel 64 and a display position of an icon or the like displayed in the display 72.

The information processing apparatus 12 outputs information to the output apparatuses below, which are loaded in the vehicle 10. An HMI 66 for an output system and an audio/visual apparatus (referred to below as an AV apparatus) 68 are loaded in the vehicle 10, as the output apparatuses.

The HMI 66 of the output system provides information and notifications to the user, through sound, voice, music, characters, images, and the like. The vehicle 10 of the present embodiment includes the speaker 70 and the display 72, as the HMI 66. The speaker 70 provides information and notifications to the user through sound, voice, music, and the like. The display 72 provides information and notifications to the user through characters, images, and the like.

The AV apparatus 68 receives a radio broadcast signal, a television broadcast signal, or the like, and controls the speaker 70 and the display 72 to output sound, voice, music, characters, images, and the like according to the received signal. The sound, voice, music, characters, images, and the like output from the speaker 70 and the display 72 may be stored within the AV apparatus 68, stored within removable media, or distributed via streaming.

The information processing apparatus 12 includes an internal camera switch information acquiring section 74, a user image acquiring section 76, a vehicle information acquiring section 78, a user information acquiring section 80, a road information acquiring section 82, a weather information acquiring section 84, a learning result acquiring section 86, an emotion estimating section 88, and a virtual assistant control section 90.

The internal camera switch information acquiring section 74 acquires the state (ON or OFF) of the internal camera switch 62. The internal camera switch information acquiring section 74 corresponds to an OFF information acquiring section of the present invention.

The user image acquiring section 76 acquires an image of the user from the internal camera 58. When the internal camera switch 62 is in the OFF state, an image of the user is not acquired. The user image acquiring section 76 corresponds to an image acquiring section of the present invention.

The vehicle information acquiring section 78 acquires vehicle behavior information of the vehicle 10 from the vehicle behavior acquisition apparatus 14, as vehicle information. Furthermore, the vehicle information acquiring section 78 acquires position information of the vehicle 10 from the positioning apparatus 20, as vehicle information. The vehicle information acquiring section 78 corresponds to a moving body information acquiring section of the present invention.

The user information acquiring section 80 acquires the manipulation amount information of a driving manipulation performed by the user from the manipulation amount acquisition apparatus 16, as user information.

The road information acquiring section 82 acquires the road information from the navigation apparatus 22 or the communication apparatus 26.

The weather information acquiring section 84 acquires the weather information from the communication apparatus 26.

The learning result acquiring section 86 acquires learning results that are machine-learned for each user, by a machine learning apparatus 92 described further below, concerning the association between the emotion of the user and the vehicle information and user information.

When the internal camera switch 62 is in the ON state, the emotion estimating section 88 estimates the emotion of the user based on the acquired image of the user. When the internal camera switch 62 is in the OFF state, the emotion estimating section 88 estimates the emotion of the user based on the acquired vehicle information, user information, road information, and weather information. The emotion estimating section 88 does not need to use all of the information including the vehicle information, user information, road information, and weather information to estimate the emotion of the user, and only needs to estimate the emotion of the user based on at least the vehicle information and the user information. The emotion estimating section 88 corresponds to an estimating section of the present invention.

The virtual assistant control section 90 controls the virtual assistant 112, described further below, based on the estimated emotion of the user.

Furthermore, the machine learning apparatus 92 is loaded in the vehicle 10. The machine learning apparatus 92 acquires the image of the user from the information processing apparatus 12, and estimates the emotion of the user based on the acquired image of the user. The machine learning apparatus 92 also acquires the vehicle information, the user information, the road information, and the weather information from the information processing apparatus 12. The machine learning apparatus 92 performs machine learning concerning the association between the estimated emotion of the user and the acquired vehicle information, user information, road information, and weather information, and stores the learning results for each user.

The machine learning apparatus 92 of the present embodiment is loaded in the vehicle 10, but the machine learning apparatus 92 may be loaded in an information processing terminal such as a smartphone, tablet, or personal computer carried by the user in the vehicle 10. Furthermore, the machine learning apparatus 92 may be loaded in a server that is arranged outside the vehicle 10 and is capable of communicating with the vehicle 10.

The machine learning apparatus 92 includes an internal camera switch information acquiring section 94, a user image acquiring section 96, a vehicle information acquiring section 98, a user information acquiring section 100, a road information acquiring section 102, a weather information acquiring section 104, an emotion estimating section 106, a learning section 108, and a learning result storage section 110.

The internal camera switch information acquiring section 94 acquires the state (ON or OFF) of the internal camera switch 62 from the information processing apparatus 12.

The user image acquiring section 96 acquires the image of the user from the information processing apparatus 12.

The vehicle information acquiring section 98 acquires the vehicle information (vehicle behavior information and position information of the vehicle 10) from the information processing apparatus 12.

The user information acquiring section 100 acquires the user information (manipulation amount information of the driving manipulation performed by the user) from the information processing apparatus 12.

The road information acquiring section 102 acquires the road information from the information processing apparatus 12.

The weather information acquiring section 104 acquires the weather information from the information processing apparatus 12.

The emotion estimating section 106 estimates the emotion of the user based on the image of the user.

The learning section 108 performs machine learning concerning the association between the estimated emotion of the user and the vehicle information, user information, road information, and weather information acquired at that time.

The learning result storage section 110 stores, for each user, the learning results concerning the association between the emotion of the user and the vehicle information, user information, road information, and weather information.

### Outline of the Emotion Estimation Based on the Learning Results

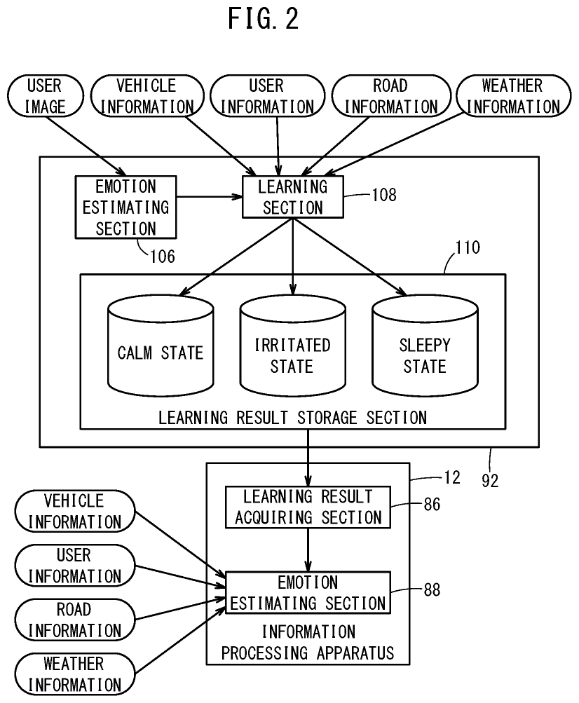

FIG. 2 is a diagram for describing an outline of the emotion estimation based on the machine learning in the machine learning apparatus 92 and the learning results in the information processing apparatus 12.

The emotion estimating section 106 of the machine learning apparatus 92 analyzes the image of the user and estimates the emotion of the user.

If the estimated emotion of the user is “calm”, the learning section 108 learns the vehicle information, user information, road information, and weather information acquired at this time as a “calm state”. If the estimated emotion of the user is “irritated”, that is, if the user is feeling annoyed, the learning section 108 learns the vehicle information, user information, road information, and weather information acquired at this time as an “irritated state”. If the estimated emotion of the user is “sleepy”, the learning section 108 learns the vehicle information, user information, road information, and weather information acquired at this time as a “sleepy state”. The learning section 108 of the machine learning apparatus 92 of the present embodiment learns the vehicle information, user information, road information, and weather information for three emotions of the user, which are calm, irritated, and sleepy, but may learn the vehicle information, user information, road information, and weather information for many more emotions of the user.

The learning result storage section 110 stores the vehicle information, user information, road information, and weather information as learning results for each of the “calm state”, the “irritated state”, and the “sleepy state”.

The learning result acquiring section 86 of the information processing apparatus 12 acquires the learning results stored in the learning result storage section 110.

The emotion estimating section 88 makes an inquiry about the emotion of the user corresponding to the acquired vehicle information, user information, road information, and weather information in the learning results, to estimate the emotion of the user.

### Detailed Examples of Proposals Provided by the Virtual Assistant

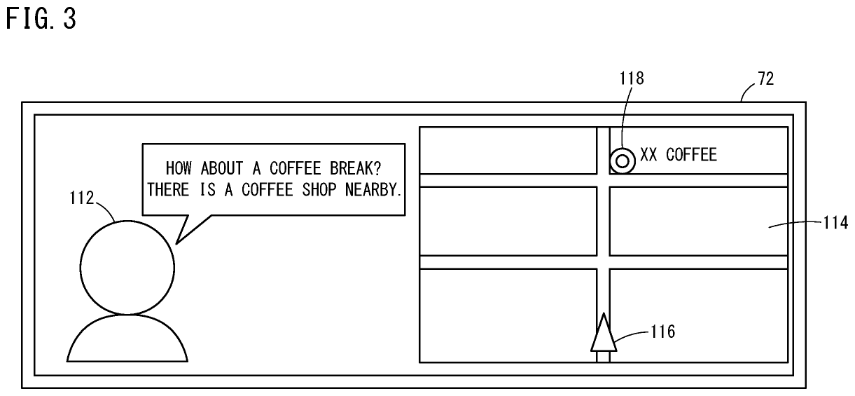

FIG. 3 shows an example of a proposal provided by the virtual assistant 112 when the emotion of the user is estimated to be “sleepy”.

The virtual assistant 112 is displayed in the display 72. Furthermore, the voice of the virtual assistant 112 is emitted from the speaker 70. The virtual assistant 112 of the present embodiment is displayed as a character with a human motif, but may instead be displayed as a character with the motif of an animal, robot, or the like. Furthermore, video obtained by actually capturing images of a person may be displayed as the virtual assistant 112. Yet further, it is acceptable for only the voice to be emitted from the speaker 70, without displaying the virtual assistant 112 in the display 72.

When the user is sleepy, the virtual assistant 112 proposes taking a break, for example. At this time, the virtual assistant 112 says to the user “How about a coffee break? There is a coffee shop nearby.” Furthermore, the virtual assistant 112 displays a surrounding map 114 of the vehicle 10 in the display 72, and displays a current position 116 of the vehicle 10 and a nearby coffee shop 118 on the surrounding map 114.

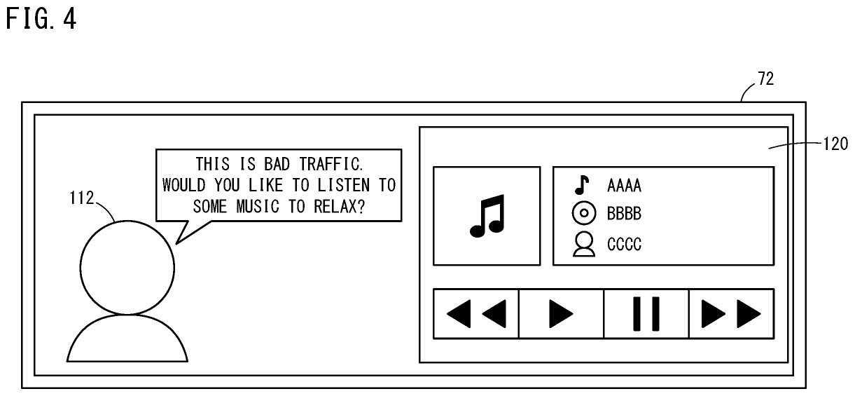

FIG. 4 shows an example of a proposal provided by the virtual assistant 112 when the emotion of the user is estimated to be “irritated”.

When the vehicle 10 is stuck in traffic and the user is annoyed, the virtual assistant 112 proposes listening to music, for example. At this time, the virtual assistant 112 says to the user “This is bad traffic. Would you like to listen to some music to relax?” Furthermore, the virtual assistant 112 selects music that calms the user down, and displays selected music information 120 in the display 72.

### Machine Learning Process

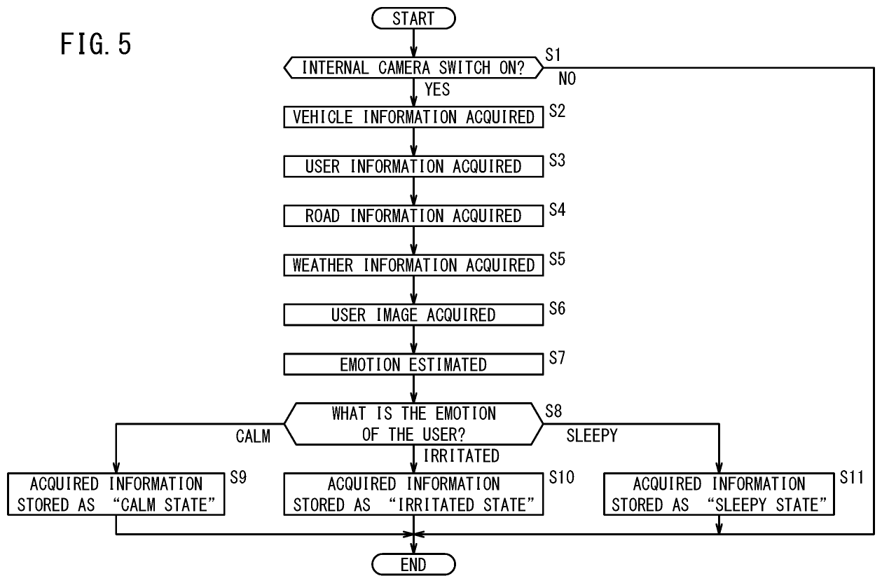

FIG. 5 is a flow chart showing the flow of the machine learning process performed by the machine learning apparatus 92.

At step S1, the machine learning apparatus 92 judges whether the state of the internal camera switch 62 acquired by the internal camera switch information acquiring section 94 is the ON state. If the state of the internal camera switch 62 is the ON state, the process moves to step S2, and if the state of the internal camera switch 62 is the OFF state, the machine learning process ends.

At step S2, the vehicle information acquiring section 98 acquires the vehicle information (vehicle behavior information and position information of the vehicle 10) from the information processing apparatus 12, and the process moves to step S3.

At step S3, the user information acquiring section 100 acquires the user information (manipulation amount information of the driving manipulation performed by the user) from the information processing apparatus 12, and the process moves to step S4.

At step S4, the road information acquiring section 102 acquires the road information from the information processing apparatus 12, and the process moves to step S5.

At step S5, the weather information acquiring section 104 acquires the weather information from the information processing apparatus 12, and the process moves to step S6.

At step S6, the user image acquiring section 96 acquires the image of the user from the information processing apparatus 12, and the process moves to step S7.

At step S7, the emotion estimating section 106 estimates the emotion of the user from the image of the user, and the process moves to step S8.

At step S8, the learning section 108 judges the emotion of the user. The process moves to step S9 if the emotion of the user is “calm”, the process moves to step S10 if the emotion of the user is “irritated”, and the process moves to step S11 if the emotion of the user is “sleepy”.

At step S9, the learning section 108 stores the acquired vehicle information, user information, road information, and weather information in the learning result storage section 110 as the “calm state”, and ends the machine learning process.

At step S10, the learning section 108 stores the acquired vehicle information, user information, road information, and weather information in the learning result storage section 110 as the “irritated state”, and ends the machine learning process.

At step S11, the learning section 108 stores the acquired vehicle information, user information, road information, and weather information in the learning result storage section 110 as the “sleepy state”, and ends the machine learning process.

### Virtual Assistant Control Process

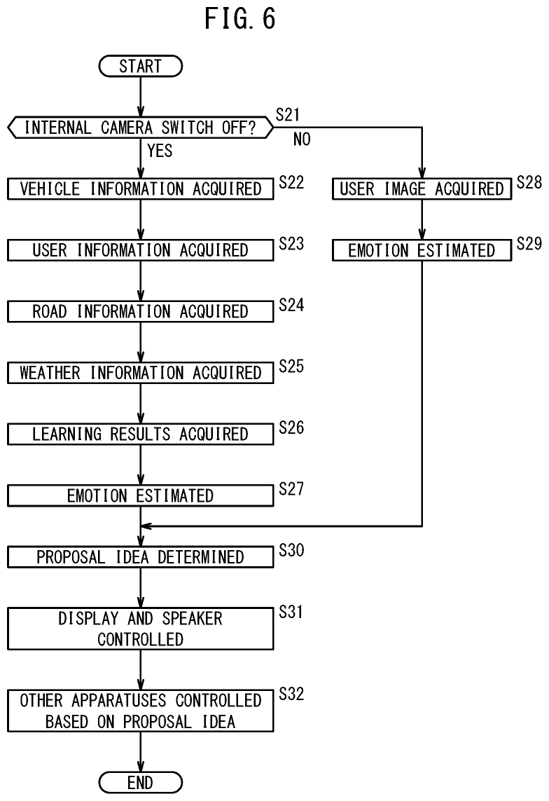

FIG. 6 is a flow chart showing the flow of the virtual assistant control process performed by the information processing apparatus 12.

At step S21, the information processing apparatus 12 judges whether the state of the internal camera switch 62 acquired by the internal camera switch information acquiring section 74 is the OFF state. If the state of the internal camera switch 62 is the OFF state, the process moves to step S22, and if the state of the internal camera switch 62 is the ON state, the process moves to step S28.

At step S22, the vehicle information acquiring section 78 acquires the vehicle information (vehicle behavior information and position information of the vehicle 10) from the vehicle behavior acquisition apparatus 14 and the positioning apparatus 20. Then, the process moves to step S23.

At step S23, the user information acquiring section 80 acquires the user information (manipulation amount information of the driving manipulation performed by the user) from the manipulation amount acquisition apparatus 16, and the process moves to step S24.

At step S24, the road information acquiring section 82 acquires the road information from the navigation apparatus 22 or the communication apparatus 26, and the process moves to step S25.

At step S25, the weather information acquiring section 84 acquires the weather information from the communication apparatus 26, and the process moves to step S26.

At step S26, the learning result acquiring section 86 acquires the learning results stored in the learning result storage section 110 of the machine learning apparatus 92, and the process moves to step S27.

At step S27, the emotion estimating section 88 makes an inquiry about the emotion of the user corresponding to the acquired vehicle information, user information, road information, and weather information in the learning results to estimate the emotion of the user, and the process moves to step S30.

At step S21, if the state of the internal camera switch 62 is the ON state, the process moves to step S28. At step S28, the user image acquiring section 76 acquires the image of the user captured by the internal camera 58, and the process moves to step S29.

At step S29, the emotion estimating section 88 estimates the emotion of the user based on the acquired image of the user, and the process moves to step S30.

At step S30, the virtual assistant control section 90 determines proposal ideas to be proposed to the user, according to the estimated emotion of the user, and the process moves to step S31. Furthermore, the virtual assistant control section 90 may reference the acquired vehicle information, user information, road information, and weather information to determine the proposal ideas. For example, when the emotion of the user is “sleepy” and there is a coffee shop near the vehicle 10, the virtual assistant control section 90 determines taking a break at the coffee shop to be a proposal idea.

At step S31, the virtual assistant control section 90 controls the display 72 to display the virtual assistant 112. Furthermore, the virtual assistant control section 90 controls the speaker 70 to vocally propose to the user the proposal idea determined by the virtual assistant 112, and the process moves to step S32.

At step S32, the virtual assistant 112 controls other apparatuses based on the determined proposal idea, and the virtual assistant control process ends. For example, if the virtual assistant control section 90 has determined the proposal idea to be taking a break at a coffee shop, the virtual assistant control section 90 controls the navigation apparatus 22 to display the surrounding map 114 of the vehicle 10 in the display 72 and to display the coffee shop 118 near the current position 116 of the vehicle 10 on the surrounding map 114.

### Operational Effect

Conventional art has been proposed to estimate the emotion of the user from the image of the user captured by the internal camera 58. However, there are cases where the image capturing of the user by the internal camera 58 is unwanted. In such a case, the image capturing by the internal camera 58 is stopped, and during this time the emotion of the user cannot be estimated from the image of the user.

Therefore, when the internal camera switch 62 is OFF, the information processing apparatus 12 of the present embodiment estimates the emotion of the user based on the vehicle information and the user information. Due to this, even when the image capturing by the internal camera 58 is stopped, the information processing apparatus 12 can estimate the emotion of the user.

Furthermore, the information processing apparatus 12 acquires the learning results from the machine learning apparatus 92. These learning results are results obtained by having the machine learning apparatus 92 estimate the emotion of the user based on the image of the user and, for each user, perform machine learning concerning the association between the estimated emotion of the user and the acquired vehicle information and user information. The information processing apparatus 12 then estimates the emotion of the user based on the acquired vehicle information and user information and the acquired learning results. In this way, even when the image capturing by the internal camera 58 is stopped, the information processing apparatus 12 can accurately estimate the emotion of the user.

### Modifications

In the first embodiment, the machine learning apparatus 92 estimates the emotion of the user based on the image of the user captured by the internal camera 58. Instead, the machine learning apparatus 92 may estimate the emotion of the user based on the biometric information of the user measured by the biometric sensor 60.

The machine learning apparatus 92 may perform both of, or only one of, the estimation of the emotion of the user based on the image of the user and the estimation of the emotion of the user based on the biometric information of the user.

There are cases where the user does not want measurement by the biometric sensor 60 to be performed, in the same manner as the cases where the user does not want the image capturing by the internal camera 58 to be performed. In such a case, the measurement by the biometric sensor 60 is stopped, and during this time the emotion of the user cannot be measured from the biometric information of the user. Accordingly, when the measurement by the biometric sensor 60 is stopped, it is effective to estimate the emotion of the user based on the acquired vehicle information and user information and the acquired learning results, in the same manner as the information processing apparatus 12 of the first embodiment.

The following describes a configuration of the information processing apparatus 12 in a case where the emotion of the user is estimated based on the biometric information of the user acquired by the biometric sensor 60. Each process performed by the information processing apparatus 12 only needs to be realized by performing the processes that were performed using the image of the user acquired by the internal camera 58 in the first embodiment while instead using the biometric information of the user measured by the biometric sensor 60.

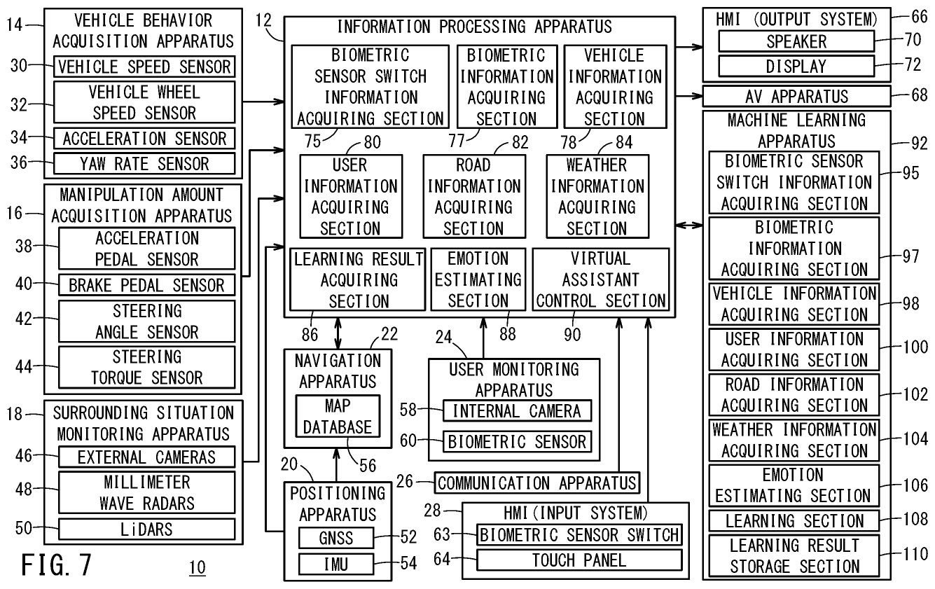

FIG. 7 is a block diagram showing the configuration of the information processing apparatus 12. The following describes only portions of the configuration differing from those of the first embodiment.

The HMI 28 of the input system includes a biometric sensor switch 63 instead of the internal camera switch 62 of the first embodiment.

The biometric sensor switch 63 is a switch for switching between an ON state in which measurement of the biometric information of the user by the biometric sensor 60 is performed and an OFF state in which measurement of the biometric information of the user by the biometric sensor 60 is stopped.

The information processing apparatus 12 includes a biometric sensor switch information acquiring section 75 instead of the internal camera switch information acquiring section 74 of the first embodiment, and a biometric information acquiring section 77 instead of the user image acquiring section 76 of the first embodiment.

The biometric sensor switch information acquiring section 75 acquires the state (ON or OFF) of the biometric sensor switch 63. The biometric sensor switch information acquiring section 75 corresponds to the OFF information acquiring section of the present invention.

The biometric information acquiring section 77 acquires the biometric information of the user from the biometric sensor 60. When the biometric sensor 60 is in the OFF state, the biometric information of the user is not acquired. The “OFF state” includes cases in which information cannot be acquired from the biometric sensor 60.

The machine learning apparatus 92 includes a biometric sensor switch information acquiring section 95 instead of the internal camera switch information acquiring section 94 of the first embodiment, and a biometric information acquiring section 97 instead of the user image acquiring section 96.

### Technical Concepts Obtainable from the Embodiments

The following is a record of technical concepts that can be understood from the embodiments described above.

An information processing apparatus (12) comprises an OFF information acquiring section (74) configured to acquire OFF information of stopping image capturing of a user of a moving body (10); an image acquiring section (76) configured to acquire an image obtained by the image capturing of the user; a moving body information acquiring section (78) configured to acquire moving body information including behavior of the moving body; a user information acquiring section (80) configured to acquire user information that is information of the user; and an estimating section (88) configured to, when at least the OFF information is acquired, estimate an emotion of the user based on the acquired moving body information and user information. Due to this, even when the image capturing by the internal camera is stopped, the information processing apparatus can estimate the emotion of the user.

In the information processing apparatus described above, the moving body information may include position information of the moving body. Due to this, even when the image capturing by the internal camera is stopped, the information processing apparatus can accurately estimate the emotion of the user.

The information processing apparatus described above may comprise a learning result acquiring section (86) configured to acquire results obtained by estimating the emotion of the user based on the acquired image and, for each of a plurality of the users, performing machine learning concerning an association between the estimated emotion of the user and the acquired moving body information and user information, and the estimating section may be configured to estimate the emotion of the user based on the acquired moving body information and user information and the acquired results of the machine learning. Due to this, even when the image capturing by the internal camera is stopped, the information processing apparatus can accurately estimate the emotion of the user.

In the information processing apparatus described above, the estimating section may estimate at least sleepiness as the emotion of the user. Due to this, even when the image capturing by the internal camera is stopped, the information processing apparatus can estimate the emotion of the user to be “sleepy”.

An information processing method comprises an OFF information acquiring step of acquiring OFF information of stopping image capturing of a user of a moving body (10); an image acquiring step of acquiring an image obtained by the image capturing of the user; a moving body information acquiring step of acquiring moving body information including behavior of the moving body; a user information acquiring step of acquiring user information that is information of the user; and an estimating step of, when at least the OFF information is acquired, estimating an emotion of the user based on the acquired moving body information and user information. Due to this, even when the image capturing by the internal camera is stopped, the information processing apparatus can estimate the emotion of the user.

An information processing apparatus (12) comprises an OFF information acquiring section (75) that acquires OFF information stopping biometric information measurement of a user of a moving body (10); biometric information acquiring section (77) that acquires the measured biometric information of the user; a moving body information acquiring section (78) that acquires moving body information including behavior of the moving body; a user information acquiring section (80) that acquires user information that is information of the user; and an estimating section (88) that, when at least the OFF information is acquired, estimates an emotion of the user based on the acquired moving body information and user information. Due to this, even when the biometric information measurement performed by the biometric sensor is stopped, the information processing apparatus can estimate the emotion of the user.

The present invention is not particularly limited to the embodiment described above, and various modifications are possible without departing from the gist of the present invention.

What is claimed is:

1. An information processing apparatus comprising:
an OFF information acquiring section configured to acquire OFF information of stopping image capturing of a user of a moving body;
an image acquiring section configured to acquire an image obtained by the image capturing of the user;
a moving body information acquiring section configured to acquire moving body information including behavior of the moving body;
a user information acquiring section configured to acquire user information that is information of the user; and
an estimating section configured to, when at least the OFF information is acquired, estimate an emotion of the user based on the acquired moving body information and user information.

2. The information processing apparatus according to claim 1, wherein the moving body information includes position information of the moving body.

3. The information processing apparatus according to claim 1, comprising a learning result acquiring section configured to acquire results obtained by estimating the emotion of the user based on the acquired image and, for each of a plurality of the users, performing machine learning concerning an association between the estimated emotion of the user and the acquired moving body information and user information,
wherein the estimating section is configured to estimate the emotion of the user based on the acquired moving body information and user information and the acquired results of the machine learning.

4. The information processing apparatus according to claim 1, wherein
the estimating section estimates at least sleepiness as the emotion of the user.

5. An information processing method comprising:
an OFF information acquiring step of acquiring OFF information of stopping image capturing of a user of a moving body;
an image acquiring step of acquiring an image obtained by the image capturing of the user;
a moving body information acquiring step of acquiring moving body information including behavior of the moving body;
a user information acquiring step of acquiring user information that is information of the user; and
an estimating step of, when at least the OFF information is acquired, estimating an emotion of the user based on the acquired moving body information and user information.
